(19) United States
(12) Patent Application Publication
(10) Pub. No.: US 2026/0148574 A1
(43) Pub. Date: May 28, 2026

(54) COOKING APPARATUS AND CONTROLLING METHOD THEREOF

(71) Applicant: SAMSUNG ELECTRONICS CO., LTD., Suwon-si (KR)

(72) Inventors: Keehwan KA, Suwon-si (KR); Seongjoo HAN, Suwon-si (KR)

(73) Assignee: SAMSUNG ELECTRONICS CO., LTD., Suwon-si (KR)

(21) Appl. No.: 19/178,554

(22) Filed: Apr. 14, 2025

Related U.S. Application Data
(63) Continuation of application No. PCT/KR2023/009917, filed on Jul. 12, 2023.

(30) Foreign Application Priority Data
Oct. 25, 2022 (KR) 10-2022-0138735
Feb. 20, 2023 (KR) 10-2023-0022365

(51) Int. Cl. G06V 20/68; A47J 36/32; G06V 10/56; G06V 10/75; G06V 10/82

(52) U.S. Cl. CPC G06V 20/68; A47J 36/321; G06V 10/56; G06V 10/75; G06V 10/82

(57) ABSTRACT

A cooking apparatus includes: a chamber configured to accommodate an object to be cooked; at least one camera configured to obtain one or more images of an inside of the chamber; memory configured to store an artificial intelligence (AI) model trained for estimating a burn state of the object to be cooked; a user interface; and at least one processor operatively connected to the at least one camera, the memory, and the user interface, wherein the at least one processor, individually or collectively, is configured to: estimate the burn state of the object to be cooked based on the one or more images obtained by the at least one camera using the AI model, and control the user interface to provide a notification indicating the burn state of the object to be cooked.

### CROSS-REFERENCES TO RELATED APPLICATIONS

This application is a continuation of International Application No. PCT/KR 2023/009917, filed on Jul. 12, 2023, which claims priority to Korean Patent Application No. 10-2022-0138735, filed on Oct. 25, 2022, and Korean Patent Application No. 10-2023-0022365, filed on Feb. 20, 2023, in the Korean Intellectual Property Office, the disclosures of each are incorporated herein by reference in their entireties.

### BACKGROUND

### 1. Field

The disclosure relates to a cooking apparatus equipped with a camera for capturing an inside of a cooking chamber, and a method for controlling the cooking apparatus.

### 2. Description of Related Art

A cooking apparatus is an appliance for heating and cooking an object, such as food. Cooking apparatuses may be capable of providing various functions related to cooking, such as heating, defrosting, drying, and sterilizing the food. Examples of the cooking apparatus are ovens such as gas ovens or electric ovens, microwave heating devices (hereinafter referred to as microwaves), gas stoves, electric stoves, gas grills, or electric grills.

In general, an oven uses a heater generating heat to cook food by transferring heat directly to the food or by heating the inside of the cooking chamber. A microwave cooks food by frictional heat between molecules, which is produced by using high-frequency waves as a heat source to disturb molecular arrangement of the food.

Recently, technologies have emerged that recognize a cooking state of food from an image captured by a camera installed in a chamber of a cooking apparatus. However, there is still a need for cooking apparatuses that recognize a burn state of the food and notify a user of the burn state of the food.

### SUMMARY

Provided are a cooking apparatus that may recognize a burn state of food using an artificial intelligence model and notify a user of the burn state of the food, and a method for controlling the same.

According to an aspect of the disclosure, a cooking apparatus includes: a chamber configured to accommodate an object to be cooked; at least one camera configured to obtain one or more images of an inside of the chamber; memory configured to store an artificial intelligence (AI) model trained for estimating a burn state of the object to be cooked; a user interface; and at least one processor operatively connected to the at least one camera, the memory, and the user interface, wherein the at least one processor, individually or collectively, is configured to: estimate the burn state of the object to be cooked based on the one or more images obtained by the at least one camera using the AI model, and control the user interface to provide a notification indicating the burn state of the object to be cooked.

According to an aspect of the disclosure, a method for controlling a cooking apparatus, includes: obtaining one or more images of an inside of a chamber; estimating a burn state of an object to be cooked based on the one or more images using an artificial intelligence (AI) model trained for estimating the burn state of the object to be cooked; and providing, via a user interface, a notification indicating the burn state of the object to be cooked.

According to an aspect of the disclosure, a non-transitory computer-readable medium stores one or more instructions that are executable by at least one processor, individually or collectively, cause the at least one processor to: obtain one or more images of an inside of a chamber; estimate a burn state of an object to be cooked based on the one or more images using an artificial intelligence (AI) model, the AI model being trained for estimating the burn state of the object to be cooked; and provide, via a user interface, a notification indicating the burn state of the object to be cooked.

Technical objects that can be achieved by the disclosure are not limited to the above-mentioned objects, and other technical objects not mentioned will be clearly understood by one of ordinary skill in the art to which the disclosure belongs from the following description.

According to an aspect of one or more embodiments of the disclosure, a burn state of food in a chamber may be estimated using a trained model, thereby accurately identifying whether the food is burned or not.

According to an aspect of one or more embodiments the disclosure, a burn state of food may be notified to a user, thereby providing accurate cooking information to the user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network system implemented by various electronic devices;

FIG. 2 is a perspective view of a cooking apparatus according to an embodiment;

FIG. 3 is a cross-sectional view of a cooking apparatus according to an embodiment;

FIG. 4 illustrates an example in which a tray is placed on a first support of a chamber side wall;

FIG. 5 is a control block diagram of a cooking apparatus according to an embodiment;

FIG. 6 illustrates an example structure of a controller described in FIG. 5;

FIG. 7 illustrates an example of a trained model of a cooking apparatus according to an embodiment;

FIG. 8 illustrates a table of reference images used in a trained model of a cooking apparatus according to an embodiment;

FIG. 9 is a flowchart illustrating a method for controlling a cooking apparatus according to an embodiment;

FIG. 10 illustrates a process of estimating a burn state of an object to be cooked using a trained model that combines a convolutional neural network (CNN) and a recurrent neural network (RNN) in a cooking apparatus according to an embodiment;

FIG. 11 is a flowchart illustrating operations of determining whether an object to be cooked is an object for which a burn state is recognizable in a cooking apparatus according to an embodiment;

FIG. 12 is a flowchart illustrating operations of estimating a burn state of an object to be cooked using a CNN in a cooking apparatus according to an embodiment;

FIG. 13 is a flowchart illustrating operations of estimating a burn state of an object to be cooked using a combination of CNN and RNN in a cooking apparatus according to an embodiment;

FIG. 14 illustrates burn states of an object to be cooked by class as estimated by a trained model in a cooking apparatus according to an embodiment;

FIG. 15 is a graph illustrating burn states of an object to be cooked by class over time in a cooking apparatus according to an embodiment;

FIG. 16 illustrates burn state sections of an object to be cooked by class in a cooking apparatus according to an embodiment;

FIG. 17 is a flowchart illustrating control based on a difference between a current burn class and a target burn class;

FIG. 18 illustrates a screen for setting a burn state identification function in a cooking apparatus according to an embodiment;

FIG. 19 illustrates a screen for setting a burn state notification function by class in a cooking apparatus according to an embodiment;

FIG. 20 illustrates a screen for setting a control function upon detection of a burn state in a cooking apparatus according to an embodiment;

FIG. 21 illustrates a screen for setting a control function based on a difference between a current burn class and a target burn class in a cooking apparatus according to an embodiment; and

FIG. 22 illustrates a screen for setting a control function by burn class in a cooking apparatus according to an embodiment.

### DETAILED DISCLOSURE

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “at least one of A, B and C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

According to an aspect of the disclosure, a burn state of food in a chamber may be estimated using a trained model, thereby accurately identifying whether the food is burned or not.

According to an aspect of the disclosure, a burn state of food may be notified to a user, thereby providing accurate cooking information to the user.

Hereinafter, the principles of operation and embodiments of the disclosure will be described with reference to the accompanying drawings.

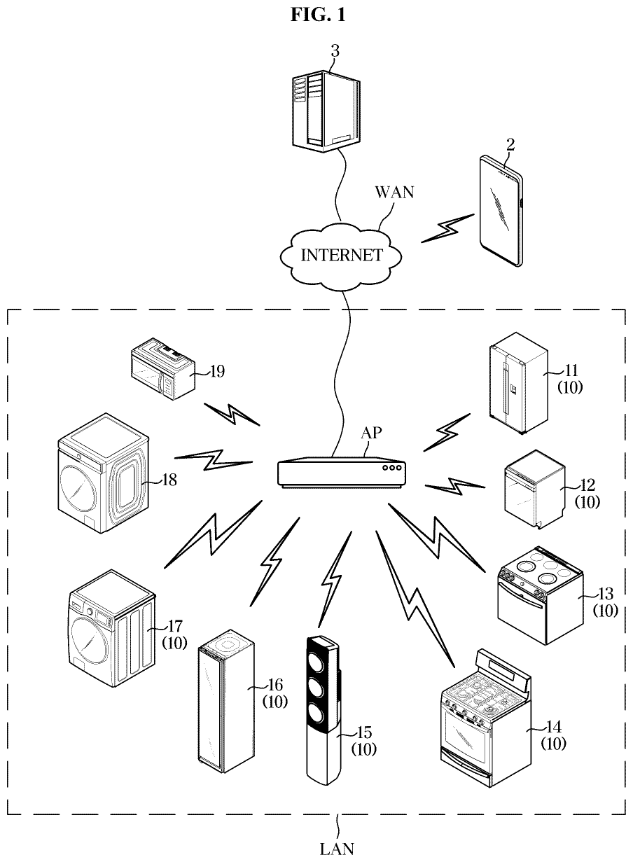

FIG. 1 illustrates a network system implemented by various electronic devices.

Referring to FIG, 1, a home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include a refrigerator 11, a dishwasher 12, an electric range 13, an electric oven 14, an air conditioner 15, a clothes treating apparatus 16, a washing machine 17, a dryer 18, and a microwave oven 19, but is not limited thereto. For example, the home appliance 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the home appliance 10 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e., an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi™ (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to the user device 2 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2 or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information associated with a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

A cooking apparatus 1 described below corresponds to the above-descried home appliance 10.

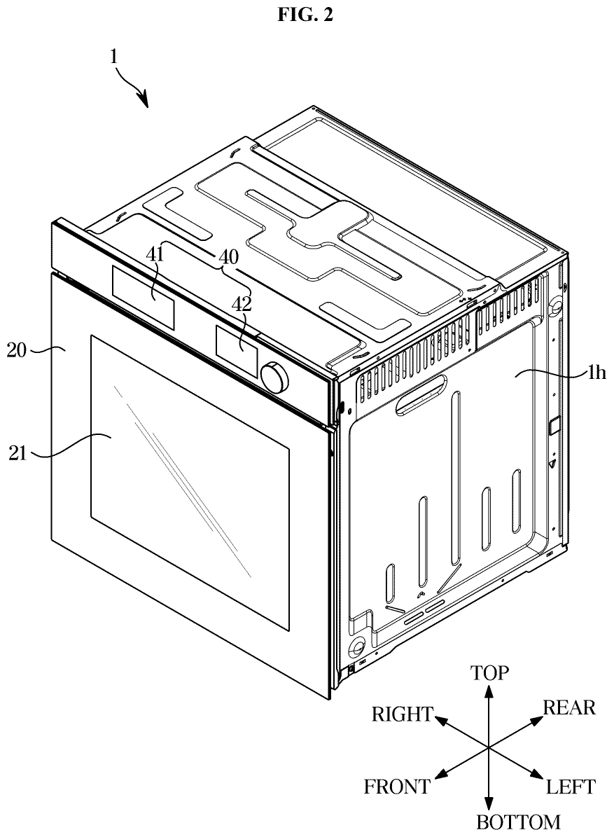

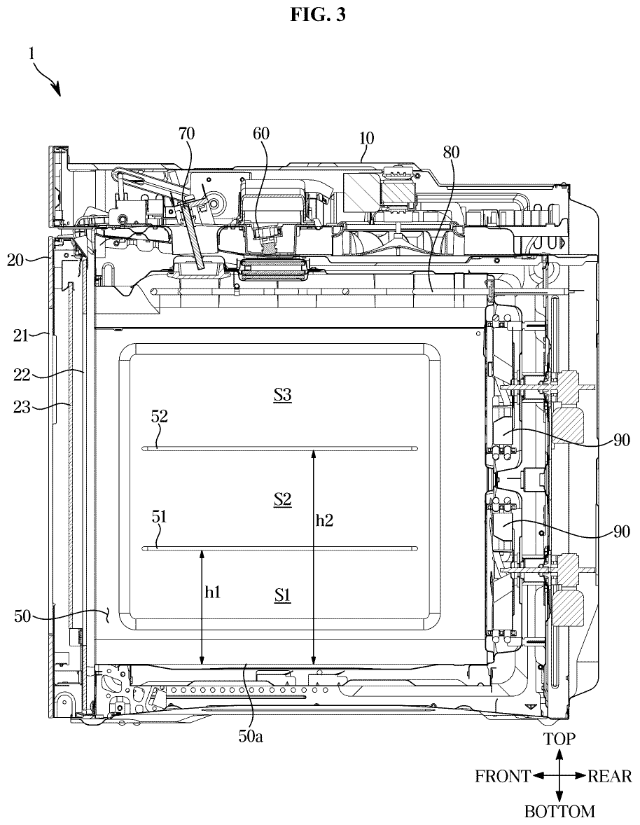

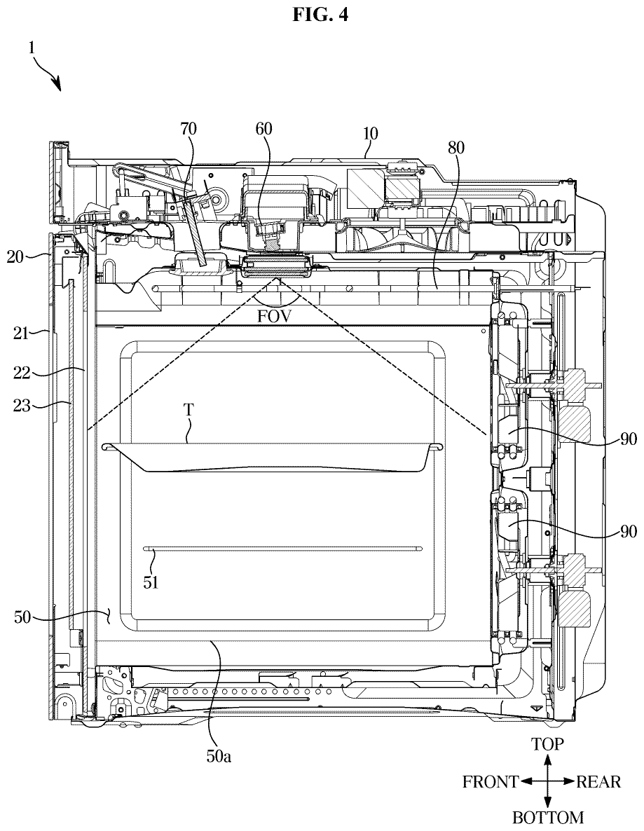

FIG. 2 is a perspective view of a cooking apparatus according to an embodiment. FIG. 3 is a cross-sectional view of a cooking apparatus according to an embodiment. FIG. 4 is a view illustrating an example in which a tray is placed on a first support of a chamber side wall.

Referring to FIG. 2, FIG. 3, and FIG. 4, the cooking apparatus 1 may include a housing 1h forming an exterior, and a door 20 for opening and closing an opening of the housing 1h. The door 20 may include at least one transparent glass plate 21. For example, the door 20 may include a first transparent glass plate 21 forming an outer surface of the door 20 and a second transparent glass plate 22 forming an inner surface of the door 20. In addition, a third transparent glass plate 23 may be arranged between the first transparent glass plate 21 and the second transparent glass plate 22. Although the door 20 is exemplified as including three transparent glass plates, the disclosure is not limited thereto. The door 20 may include two transparent glass plates or four transparent glass plates.

The at least one transparent glass plates 21, 22, and 23 included in the door 20 may function as a window. A user may see the inside of a chamber 50 through the transparent glass plates 21, 22, and 23 when the door 20 is closed. The transparent glass plates 21, 22, and 23 may be made of heat-resistant glass.

A user interface 40 configured to display information associated with an operation of the cooking apparatus 1 and obtain a user input may be disposed on the housing 1h of the cooking apparatus 1. The user interface 40 may include a display 41 to display information associated with the operation of the cooking apparatus 1 and an input device 42 to obtain a user input. The display 41 and the input device 42 may be disposed at various positions of the housing 1h. For example, the display 41 and the input device 42 may be located on an upper front side of the housing 1h. The display 41 and the input device 42 may also be embodied by a same component and may be disposed on the housing 1h.

The display 41 may be provided as various types of display panels. For example, the display 41 may include a liquid crystal display (LCD) panel, a light emitting diode (LED) panel, an organic light emitting diode (OLED) panel, or a micro-LED panel. The display 41 may also be used as an input device by including a touch screen to be used.

The display 41 may display information input by the user or information to be provided to the user as various screens. The display 41 may display information associated with the operation of the cooking apparatus 1 in at least one of an image or text. In addition, the display 41 may display a graphic user interface (GUI) that enables the cooking apparatus 1 to be controlled. That is, the display 41 may display a user interface element (UI element) such as an icon.

The input device 42 may transmit an electrical signal (voltage or current) corresponding to the user input to a controller 200. The input device 42 may include various buttons and/or a dial. For example, the input device 42 may include at least one of a power button to power on or off the cooking apparatus 1, a start/stop button to start or stop a cooking operation, a cooking course button to select a cooking course, a temperature button to set a cooking temperature, or a time button to set a cooking time. Such various buttons may be provided as physical buttons or touch buttons.

The dial included in the input device 42 may be rotatably provided. One of a plurality of cooking courses may be selected by turning the dial. The UI elements displayed on the display 41 may be sequentially shifted by turning the dial. The cooking apparatus 1 may perform cooking according to the selected cooking course. The cooking course may include cooking parameters such as cooking temperature, cooking time, output of the heater 80 and output of a fan 90. Different cooking courses may be selected depending on the position of a tray T, and the type, quantity, and/or size of an object to be cooked (hereinafter also referred to as ‘food’).

The cooking apparatus 1 may include the chamber 50 located in the housing 1h and containing food. An opening may be formed on the front of the housing 1h. The user may put the food into the chamber 50 through the opening of the housing 1h. The chamber 50 may be provided in the form of a rectangular parallelepiped

A plurality of supports 51 and 52 may be arranged on the left and right inner walls of the chamber 50 to place the tray T. The supports may also be referred to as rails. For example, the plurality of supports 51 and 52 may be formed to protrude from left and right inner walls of the chamber 50. In another example, the plurality of supports 51 and 52 may be separate structures to be installed at the left and right inner walls of the chamber 50.

Each of the plurality of supports 51 and 52 has a predetermined length in the front-back direction. The plurality of supports 51 and 52 may be spaced apart from each other in the vertical direction. For example, the plurality of supports 51 and 52 may include the first support 51 and the second support 52 formed at a higher position than that of the first support 51. The first support 51 may be located at a first height h1 from a bottom 50a of the chamber 50. The second support 52 may be located at a second height h2 from the bottom 50a of the chamber 50, which is higher than the first height.

The first support 51 may refer to a pair of supports located on the left and right inner walls of the chamber 50 at the first height. The second support 52 may refer to a pair of supports located on the left and right inner walls of the chamber 50 at the second height. An interior space of the chamber 50 may be divided into a plurality of levels by the plurality of supports 51 and 52. For example, the bottom 50a of the chamber 50 may form a first level S1, the first support 51 may form a second level S2, and the second support 52 may form a third level S3.

The tray T may be placed at various heights in the chamber 50 by the plurality of supports 51 and 52. For example, the tray T may be placed on the bottom 50a of the chamber 50, on the first support 51, or on the second support 52. When the tray T is placed in the chamber 50, the top side of the tray T may face the ceiling of the chamber 50. An object to be cooked may be placed on the top side of the tray T. The tray T may have various shapes. For example, the tray T may have a rectangular or circular shape.

In a case where a plurality of trays are placed simultaneously, a plurality of cooking compartments may be formed. For example, in a case where a plurality of trays are placed on all of the bottom 50a, the first support 51 and the second support 52 of the chamber 50, a first level space, a second level space, and a third level space may be formed in the chamber 50.

Although the two supports 51 and 52 at different heights on both sidewalls of the chamber 50 are illustrated, the disclosure is not limited thereto. Depending on the design, a varying number of rails may be provided. The larger the chamber 50, the greater the number of rails that may be provided.

Various components required for the operation of the cooking apparatus 1 may be arranged between the chamber 50 and the housing 1h. For example, the cooking apparatus 1 may include a camera 60, a light 70, the fan 90 and various circuits. It will be understood that the number of cameras, lights, and fans is not be limited to one in the present disclosure.

The camera 60 may obtain an image of the inside of the chamber 50. The camera 60 may transmit data of the obtained image to the controller 200. The camera 60 may include a lens and an image sensor. To secure a field of view (FOV) of the camera 60, a portion of an upper side of the chamber 50 adjacent to the position of the camera 60 may be formed with a transparent material (e.g., transparent heat-resistant glass).

The light 70 may emit light into the chamber 50. The interior of the chamber 50 may be illuminated by the light emitted from the light 70. Accordingly, brightness, contrast and/or definition of the image obtained by the camera 60 may increase, and discrimination of the object in the image may be improved. Another portion of the upper side of the chamber 50 adjacent to the position of the light 70 may be equipped with a diffuser material to transmit and diffuse the light from the light 70 into the chamber 50.

The heater 80 may be located at an upper end of the chamber 50. The heater 80 may supply heat into the chamber 50. Food may be cooked by the heat generated by the heater 80. One or more heaters 80 may be provided. A heating level and a heating time of the heater 80 may be controlled by the controller 200. An output and the heating time of the heater 80 may be controlled in different ways according to the position of the tray T in the chamber 50, the type, number, and/or size of the food. That is, the operation of the heater 80 may be controlled in different manners depending on the cooking course.

The fan 90 may circulate air in the chamber 50. The fan 90 may include a motor and a blade. At least one fan 90 may be provided. As the fan 90 operates, air heated by the heater 80 may circulate in the chamber 50. Thus, heat generated by the heater 80 may be evenly transferred from the top to the bottom of the chamber 50. A rotation speed and a rotation time of the fan 90 may be controlled by the controller 200. The operation of the fan 90 may be controlled in different manners according to the cooking course. An output and the rotation time of the fan 90 may be controlled in different ways according to the position of the tray T in the chamber 50, the type, number, and/or size of the food.

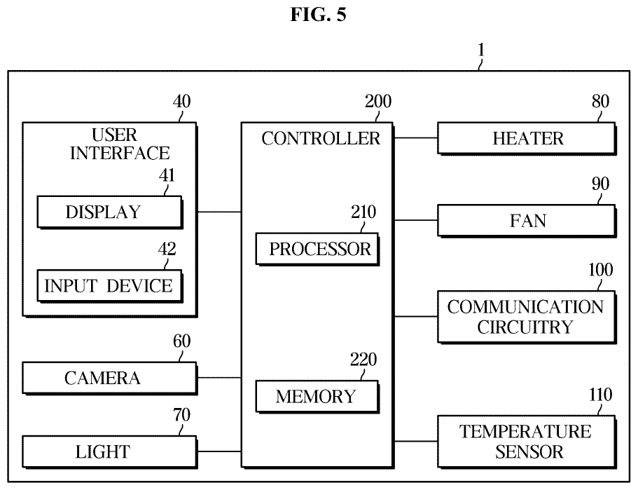

FIG. 5 is a control block diagram of a cooking apparatus according to an embodiment.

Referring to FIG. 5, the cooking apparatus 1 may include the user interface 40, the camera 60, the light 70, the heater 80, the fan 90, communication circuitry 100, a temperature sensor 110, and the controller 200. The controller 200 may be electrically connected to components of the cooking apparatus 1 and control the components of the cooking apparatus 1. In embodiments, the controller 200 may be connected to the components of the cooking apparatus 1 through wireless connection or any suitable connection to control the components of the cooking apparatus 1.

The user interface 40 may include the display 41 and the input device 42. The display 41 may display information associated with the operation of the cooking apparatus 1. The display 41 may display information input by a user or information to be provided to the user as various screens.

The input device 42 may obtain a user input. The user input may include various commands. For example, the input device 42 may obtain at least one of a command to select an item, a command to select a cooking course, a command to control a heating level of the heater 80, a command to control a cooking time, a command to control a cooking temperature, a command to start cooking or a command to stop cooking. The user input may be obtained from the user device 2.

The controller 200 may control the operation of the cooking apparatus 1 by processing the command received through at least one of the input device 42 or the user device 2. The cooking apparatus 1 may automatically perform cooking based on cooking course information obtained from the memory 220, the user device 2 or the server 3.

The camera 60 may obtain an image of the interior of the chamber 50. The camera 60 may have a predetermined field of view (FOV). The camera 60 may be positioned at an upper part of the chamber 50 and may have a FOV directed from an upper surface of the chamber 50 toward the interior of the chamber 50. The controller 200 may control the camera 60 to obtain the image of the interior of the chamber 50 when the cooking apparatus 1 is turned on and the door 20 is closed. The controller 200 may also control the camera 60 to obtain the image of the interior of the chamber 50 at predetermined intervals until cooking is completed after the cooking is started. The controller 200 may identify a burn state of the food using a plurality of images obtained while the cooking operation is performed.

The controller 200 may identify various objects included in the image of the inside of the chamber 50 obtained by the camera 60. The controller 200 may identify the food included in the image. The controller 200 may estimate the burn state of the food included in the image. The controller 200 may estimate the burn state of the food included in the image using a trained model which is obtained from the memory 220 or the server 3. The controller 200 may control the user interface 40 to notify the user of the burn state of the food.

The light 70 may emit light into the chamber 50. The controller 200 may control the light 70 to emit light when the cooking apparatus 1 is turned on. The controller 200 may control the light 70 to emit light until cooking is completed or until the cooking apparatus 1 is turned off.

The heater 80 may supply heat into the chamber 50. The controller 200 may control an output of the heater 80. For example, the controller 200 may control a heating level and a heating time of the heater 80. The controller 200 may control the heating level and the heating time of the heater 80 according to the position of a tray T in the chamber 50, characteristics of food, and/or a cooking course.

The fan 90 may circulate air in the chamber 50. The controller 200 may control an output of the fan 90. For example, the controller 200 may control a rotation speed and a rotation time of the fan 90. The controller 200 may control the rotation speed and the rotation time of the fan 90 according to the position of the tray T in the chamber 50, the type, quantity, number, and/or size of the food.

The communication circuitry 100 may perform connection to at least one of the user device 2 or the server 3 over a network. The controller 200 may obtain various information, signals, and/or data from the server 3 via the communication circuitry 100. For example, the communication circuitry 100 may receive a remote-control signal from the user device 2. The controller 200 may acquire a trained model used for image analysis from the server 3 via the communication circuitry 100.

The communication circuitry 100 may include various communication modules. The communication circuitry 100 may include a wireless communication module and/or a wired communication module. As the wireless communication technology, a wireless local area network (LAN), a home radio frequency (RF), infrared communication, ultra-wide band (UWB) communication, Wi-Fi, Bluetooth, Zigbee, and the like, may be applied.

The temperature sensor 110 may detect a temperature in the chamber 50. The temperature sensor 110 may be installed in various positions in the chamber 50. The temperature sensor 110 may transmit an electrical signal corresponding to the detected temperature to the controller 200. The controller 200 may control at least one of the heater 80 or the fan 90 to maintain the inside of the chamber 50 at a cooking temperature which is determined by the type and the number of the objects to be cooked, and/or cooking course.

In addition to the above, the cooking apparatus 1 may include various sensors. For example, the cooking apparatus 1 may include a current sensor and a voltage sensor. The current sensor may measure a current applied to the electronic components of the cooking apparatus 1. The voltage sensor may measure a voltage applied to the electronic components of the cooking apparatus 1.

The controller 200 may include a processor 210 and the memory 220. The number of processors and memory is not limited to one, and may be more than one. The processor 210 may include logic circuits and operation circuits in hardware. The processor 210 may control the connected components of the cooking apparatus 1 based on programs, instructions and/or data stored in the memory 220 for the operation of the cooking apparatus 1. The controller 200 may be implemented with a control circuit including circuit elements such as a condenser, an inductor and a resistor. The processor 210 and the memory 220 may be implemented in separate chips or in a single chip. Furthermore, the controller 200 may include a plurality of processors and a plurality of memories.

The memory 220 may store the programs, applications and/or data for the operation of the cooking apparatus 1 and store data generated by the processor 210. The memory 220 may include a non-volatile memory such as a read only memory (ROM) and a flash memory for long-term data storage. The memory 220 may include a volatile memory for temporarily storing data, such as a static random access memory (S-RAM) and a dynamic random access memory (D-RAM).

The components of the cooking apparatus 1 are not limited the above-described components. The cooking apparatus 1 may further include various components in addition to the aforementioned components, and some of the aforementioned components may be omitted.

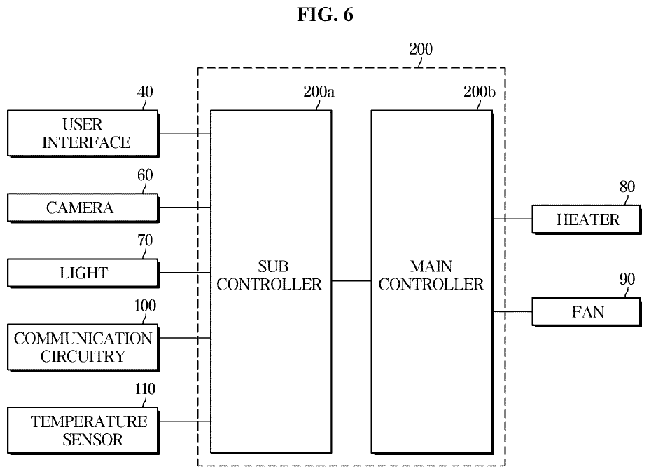

FIG. 6 illustrates an example structure of the controller described in FIG. 5.

Referring to FIG. 6, the controller 200 may include a sub-controller 200a and a main controller 200b. The sub-controller 200a and the main controller 200b may be connected to each other, and may each include a processor and memory. The main controller 200b may be connected to the heater 80 and the fan 90 and may control the operations of the heater 80 and the fan 90.

The sub-controller 200a may control the operations of the user interface 40, the camera 60, the light 70, the communication circuitry 100, and the temperature sensor 110. The sub-controller 200a may process an electrical signal corresponding to a user input which is entered via the user interface 40. The sub-controller 200a may control the user interface 40 to display information about the operation of the cooking apparatus 1.

In addition, the sub-controller 200a may estimate a burn state of food in an image obtained by the camera 60 using a trained model acquired from the server 3 or stored in the memory 220. The sub-controller 200a may preprocess the image and estimate the burn state of the food from the image using the trained model. The sub-controller 200a may estimate the burn state of the food from the image of the inside of the chamber 50 obtained by the camera 60 using the trained model.

In addition, the sub-controller 200a may download a reference image used in the trained model from the server 3, and may store the reference image in the memory 220. The reference image may be stored in the memory 220 when the cooking apparatus 1 is shipped from a factory. The sub-controller 200a may transmit the reference image stored in the memory 220 to the server 3. The server 3 may train a training model, which is an artificial intelligence (AI) model before learning within the server, by using the received reference image, and may generate a trained model. The sub-controller 200a may download the trained model, created by the server 3, from the server 3 and may store the trained model in the memory 220. The sub-controller 200a may download the trained model from the server 3 and store the trained model in the memory 220. The trained model may be stored in the memory 220 when the cooking apparatus 1 is shipped from a factory.

Meanwhile, the sub-controller 200a may preprocess the image of the inside of the chamber 50 and estimate the burn state of the food from the image using the trained model stored in the memory 220. The sub-controller 200a may estimate the burn state of the food by converting the trained model stored in the memory 220. The sub-controller 200a may estimate the burn state of the food included in the image by inputting the image obtained by the camera 60 into the trained model. By inputting the image of the inside of the chamber into the trained model, the trained model may output the burn state of the food through model conversion to obtain a food image recognition result.

The trained model refers to an AI model. The trained model may be created by machine learning and/or deep learning. The trained model may be created by the server 3 and may be stored in the memory 220 of the cooking apparatus 1. A learning algorithm may include, for example, supervised learning, unsupervised learning, semi-supervised learning, or reinforcement learning, but is not limited thereto.

The trained model may include a plurality of artificial neural network layers. The artificial neural network may include deep neural network (DNN), convolutional neural network (CNN), recurrent neural network (RNN), Restricted Boltzmann Machine (RBM), deep belief network (DBN), bidirectional recurrent deep neural network (BRDNN), and/or deep Q-networks, but is not limited thereto. Additionally or alternatively, the AI model may include a software structure in addition to the hardware structure.

The sub-controller 200a may include a special processor capable of performing multiple input-multiple output operations (i.e., matrix operation) to process artificial intelligence algorithms. The special processor included in the sub-controller 200a may be referred to as a neural process unit (NPU).

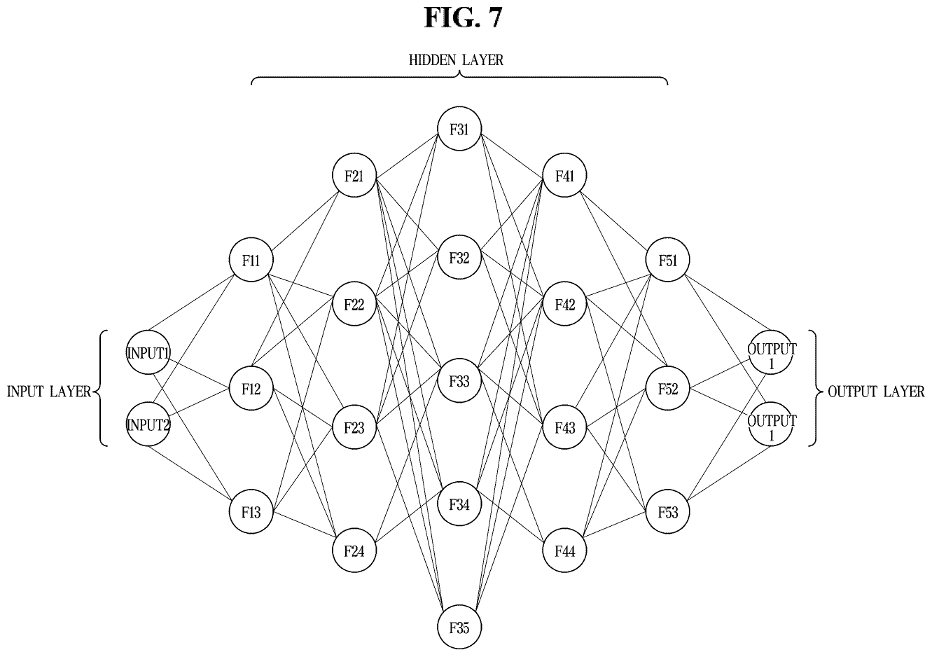

FIG. 7 illustrates an example of a trained model of a cooking apparatus according to an embodiment.

Referring to FIG. 7, in a case where the trained model is an artificial neural network model, the trained model may be broadly organized into an input layer, a hidden layer, and an output layer. Each layer consists of a plurality of nodes. The input layer functions to receive values of independent variables, the hidden layer functions to perform complex calculations using the values of independent variables, and the output layer functions to output the results of analysis.

A simple overview of the mechanism of an artificial neural network is as follows.

A value of an independent variable of each data in a batch is fed into a corresponding node in the input layer. Then, a weighted sum is calculated by multiplying the value of the independent variable in each node of the input layer by random weights. The calculated values are fed into the corresponding nodes in the hidden layer. The values in each node of the hidden layer are then multiplied by random weights, and the weighted sum is calculated again. The calculated values are then fed into the corresponding nodes in the output layer. The output layer compares the resulting value input from the hidden layer with the actual value of each data, calculates the error, which is a difference between a predicted value and the actual value, and then calculates the total error as an average error for all data in one batch. In order to reduce the total error, the artificial neural network updates the weights from the output layer to the input layer. Once the weights are updated, the data in the next batch is fed into the artificial neural network using the updated weights, and the weights are continuously updated as the above process is repeated. The above process of continuously updating the weights to reduce the error, which is the difference between the predicted value and the actual value, and identifying the optimal combination of weights is referred to as learning.

The trained model consists of multiple functions at multiple levels, and there is a first level, i.e., level 1 (F11, F12, F13), that receives an initial input value and produces an output through another function. Once the output of the function at level 1 is passed as input to level 2, the functions at level 2 (F21, F22, F23, F24) operates to produce outputs, which is repeated until it converges to a specific output value. As such, the trained model has a structure in which input values are received from the previous level, output values are passed to the next level, and such processes are repeated.

In addition, in the trained model, with respect to whether to pass input values from the functions at each level to the functions at the next level, inputs may be passed from one function to all functions at the next level (e.g., F11), or inputs may be passed from one function to only a few specific functions at the next level (e.g., F13).

In addition, the output layer of the trained model may produce outputs as a final result, which may be a single output value or multiple outputs. In this instance, the size of the level or function may be changed depending on the model capacity or target, and there may be structural parts where calculations are performed by skipping several steps.

In creating the trained model, the model may be created using two input images, i.e., an initial image and a current image. The input value in the input layer of the trained model may be set to one, but the two input values are set to compare the initial image of the food with the current image after the food is burned to output the result value and estimate a burn state of the food. That is, in a case where only the current image is used, the type or characteristics of the food may not be considered, whereas in a case where the initial image is used together with the current image, the initial state of the food is considered, and thus the characteristics of the food and a change due to cooking may be considered together.

Meanwhile, the process in which the initial inputs of the trained model become the inputs to F11, F12, F13, and the outputs resulting from the execution of functions F11, F12, F13 become the inputs to F21, F22, F23, F24 is represented by lines.

The inputs and outputs may be entered as the output of the next level function with the same weight. However, in the trained model for inferring more accurate recognition results, each input may have a different weight. Each weight may be the same value or different values.

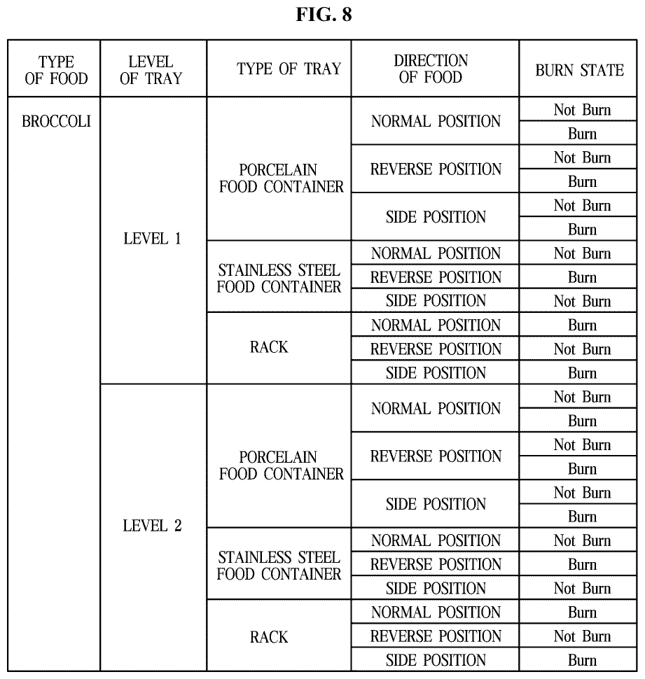

FIG. 8 illustrates a table of reference images used in a trained model of a cooking apparatus according to an embodiment.

Referring to FIG. 8, the trained model is trained using reference images that are training data acquired through experiments performed in advance.

For example, the trained model is trained by adjusting internal variables between nodes included in the input layer, hidden layer, and output layer through deep learning using the reference images obtained through experiments performed in advance.

The reference images are compared with the image obtained by the camera 60.

The reference image may be a database of captured images according to the type of food, the level (height) of a tray on which the food is placed (level 1, level 2, etc.), the type and material of the tray on which the food is placed (porcelain food container, stainless steel food container, rack, etc.), the direction in which the food is placed (normal position, reverse position, side position, etc.), the initial state of the food (not burn), the burned state (burn), etc. In addition, images according to the amount of food, the presence of garnish, etc., may be considered.

The reference images may be used for model training and evaluation as datasets for creating the trained model, and may be divided into three datasets: a training set, a validation set, and a test set.

The training set is data used directly for training the trained model, and is used to find the optimal internal variables. The validation set is data used for intermediate validation during training to evaluate the model trained from the training set. The test set is data used to verify a final performance of the trained model.

In addition to the height of the tray on which the food is placed, the type and material of the tray on which the food is placed, and the direction in which the food is placed, the reference image may include images of the initial state of the food before cooking, and the state of the food, such as the burned state. As a result, the trained model created by the reference images may increase the accuracy of estimating a burn level of the food.

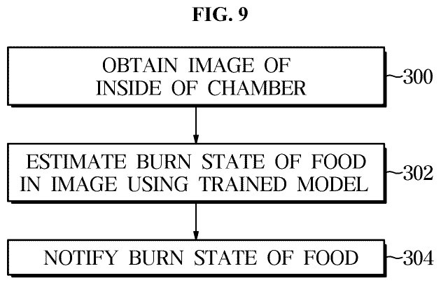

FIG. 9 is a flowchart illustrating a method for controlling a cooking apparatus according to an embodiment.

Referring to FIG. 9, the controller 200 of the cooking apparatus 1 may control the camera 60 to obtain an image of the inside of the chamber 50 (300). The controller 200 may identify food included in the image. The controller 200 may identify the food included in the image using the trained model stored in the memory 220.

The controller 200 may distinguish a food segmentation image in the image of the inside of the chamber 50 by image segmentation. Image segmentation is a method of distinguishing a region of a particular object from another object in the entire image. The controller 200 may distinguish a food region from another region in the image of the inside of the chamber 50 by image segmentation.

The controller 200 may estimate a burn state of the food included in the image using the trained model stored in the memory 220 (302). The controller 200 may estimate the burn state of the food by inputting the food segmentation image, distinguished from the image of the inside of the chamber 50, into the trained model. The burn state of the food may include a state in which the food is not burned and a state in which the food is burned. In addition, the burn state of the food may include a burn level of the food in stages. For example, the burn level may include a ‘not burn’ state in which the food is not burned, a ‘close to burn’ state in which the food is close to being burned, a ‘burn’ state in which the food is burned, and an ‘over burn’ state in which the food is excessively burned.

The trained model is trained to output an image recognition result indicating the burn state of the food included in the image, when the image of the inside of the chamber 50 is input as input information.

The trained model may include a plurality of artificial neural network layers. The artificial neural network may include deep neural network (DNN), convolutional neural network (CNN), recurrent neural network (RNN), Restricted Boltzmann Machine (RBM), deep belief network (DBN), bidirectional recurrent deep neural network (BRDNN), and/or deep Q-networks, but is not limited thereto.

The controller 200 may notify a user of the burn state of the food via the user interface 40 (304). The controller 200 may display the burn state of the food via the user interface 40, or may output a voice to inform the user of the burn state of the food. Accordingly, the food may be prevented from burning in advance during heating cooking.

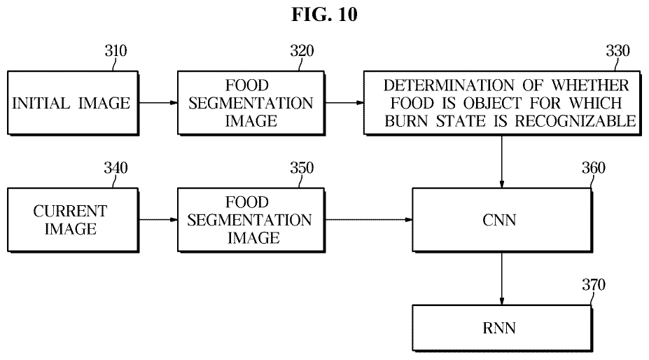

FIG. 10 illustrates a process of estimating a burn state of food using a trained model that combines a CNN and a RNN in a cooking apparatus according to an embodiment.

Referring to FIG. 10, the controller 200 may obtain an initial image of the inside of the chamber 50 before a heating and cooking process (310), may obtain an initial food segmentation image, included in the initial image, from the initial image (320), and may determine whether the food in the initial food segmentation image is an object for which a burn state is recognizable (330).

In a case where the food is an object for which a burn state is recognizable, the controller 200 may start the heating and cooking process according to the type of food, and then obtain a current image of the inside of the chamber 50 (340). In addition, the controller 200 may obtain a current food segmentation image, included in the current image, from the current image (350), and may estimate a current burn state of the food by inputting the current food segmentation image or by inputting the initial food segmentation image and the current food segmentation image into CNN (360).

In general, CNN is an artificial neural network specialized in image classification and consists of a convolution layer, a pooling layer, and a fully connected layer. The convolution layer and the pooling layer use a filter or kernel to extract feature information of a given range of convolutions. Because partial data is derived while performing the convolution operations, the pooling layer reduces the size of the features while repeatedly identifying pattern information in the segmented images. Such partial image information is then combined and converted into a unique feature map that contains only the invariant pattern information in the image, not the image itself. The fully connected layer performs classification based on the feature map extracted through the convolution layer and the pooling layer.

Meanwhile, the controller 200 may extract a current burn feature of the food by inputting the current food segmentation image or both the initial food segmentation image and the current food segmentation image into CNN, and then may estimate the current burn state of the food by inputting the extracted burn feature into RNN (370).

RNN is an artificial neural network specialized in processing time-series data. RNN repeats itself through an internal recurrent structure and continuously reflects past training values as current training values. To analyze the current state, RNN uses not only the training value at the current time, but also training information about the previous state. When a new value is entered, RNN does not estimate the predicted value using only the current value, but uses the result values of the previous values for analysis. As a result, RNN may estimate the burn state including a burn change rate and/or burn trend of the food.

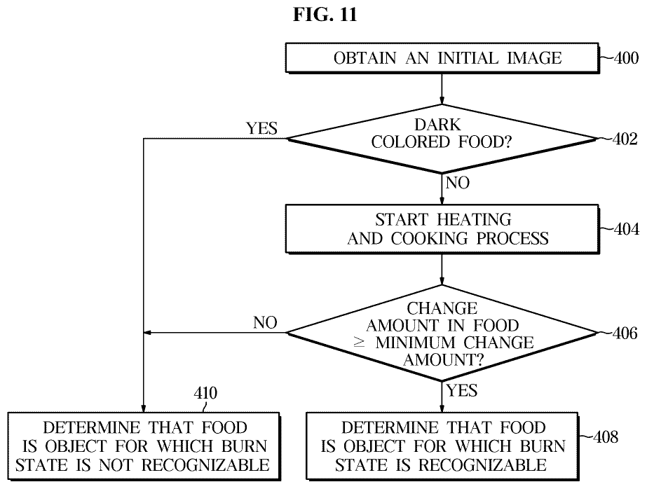

FIG. 11 is a flowchart illustrating operations of determining whether food is an object for which a burn state is recognizable in a cooking apparatus according to an embodiment.

Referring to FIG. 11, to accurately estimate a burn state of food, whether the food is an object for which a burn state is recognizable requires to be distinguished.

When the food is placed in the chamber 50, the controller 200 may obtain an initial image of the inside of the chamber 50 through the camera 60 (400). The controller 200 may obtain the initial image of the inside of the chamber 50 before a heating and cooking process.

The controller 200 may identify whether the food included in the initial image is a dark colored food (402).

In a case where the food is a dark colored food (Yes in operation 402), the controller 200 may determine that the food in the chamber 50 is an object for which a burn state of the food is not recognizable (410).

Before the heating and cooking process starts, it may be determined whether the food is too dark in color to determine whether the burn state of the food is recognizable. In the case of food such as chocolate brownies, because the color of the food is dark, there is little change in color after heating. Accordingly, the unburned and burned states of the food are not distinguished, and thus the burn state may not be easily identified. As a result, in the case of dark colored food, the food may be determined as an object for which a burn state is not recognizable so as not to confuse a user.

Meanwhile, in a case where the food is not a dark colored food (No in operation 402), the controller 200 starts the heating and cooking process according to the type of the food (404).

The controller 200 may determine whether a change amount in the food during heating and cooking is greater than or equal to a preset minimum change amount (406). In this instance, the change amount in the food may include a change in color and/or a change in shape.

In a case where the change amount in the food during heating and cooking is greater than or equal to the minimum change amount (Yes in operation 406), the controller 200 may determine the food in the chamber 50 as an object for which a burn state is recognizable (408).

Meanwhile, in a case where the change amount in the food during heating and cooking is less than the minimum change amount (No in operation 406), the controller 200 may determine the food in the chamber 50 as an object for which a burn state is not recognizable (410).

In a case where the change amount in the food is insignificant for a preset time after the start of the heating and cooking process, the food may be determined as an object for which a burn state is not recognizable. In the case of eggs or corn husks, there is no change in color or shape even though they are heated for a predetermined period of time. Accordingly, in the case of food that does not change in color and/or shape during heating, such food may be determined to be an object for which a burn state is not recognizable so as not to confuse a user.

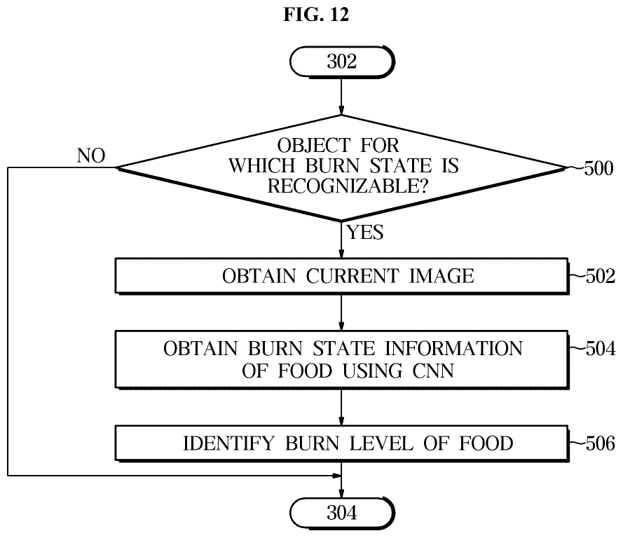

FIG. 12 is a flowchart illustrating operations of estimating a burn state of food using a CNN in a cooking apparatus according to an embodiment.

Referring to FIG. 12, the controller 200 may determine whether the food is an object for which a burn state is recognizable (500).

In a case where the food is an object for which a burn state is recognizable (Yes in operation 500), the controller 200 may obtain a current image of the inside of the chamber 50 through the camera 60 during heating and cooking (502).

The controller 200 may obtain burn state information of the food by using the image (current image or both current image and initial image) of the inside of the chamber 50 and CNN (504). In this instance, the controller 200 may obtain the burn state information of the food by inputting the current image of the food or both the initial image and current image of the food into CNN. The burn state information of the food may include a burn state such as an unburned state and a burned state of the food, and a probability value of the corresponding burn state.

The controller 200 may identify a burn level of the food based on the burn state information of the food (506).

By using the image of the inside of the chamber 50 and CNN, the current image of the food captured at the current time and the image of the burned state of the food may be compared to determine the probability of the burned state by a percentage.

For example, a result value obtained by converting CNN may include a state of the food and a probability value (%) of the corresponding state, such as ‘Chicken, Burn, 60%’ or ‘Broccoli, Burn, 80%’. Accordingly, it may be determined whether the food is burned or not at the current time. For example, in a case where a reference probability for determining a burned state is 70%, chicken may be determined as not burned, while broccoli may be determined as burned. The reference probability for determining a burned state may vary by food type.

Meanwhile, the burn state information of food may include a plurality of burn classes of the food and a probability value of a corresponding burn class. For example, the plurality of burn classes may include ‘not burn’, which is a state in which the food is not burned, ‘close to burn’, which is a state close to being burned, ‘burn’, which is a state in which the food is burned, and ‘over burn’, which is a state in which the food is excessively burned.

In this case, a result value obtained by converting CNN may be one of ‘Chicken, Not Burn, N1%’, ‘Chicken, Close to Burn, N2%’, ‘Chicken, Burn, N3%’, or ‘Chicken, Over Burn, N4%’.

Meanwhile, the result value obtained by converting CNN may include all of ‘Chicken, Not Burn, N1%’, ‘Chicken, Close to Burn, N2%’, ‘Chicken, Burn, N3%’, and ‘Chicken, Over Burn, N4%’. In this case, the four burn classes and probability values may be compared to determine one burn class and one probability value at the point in time among the four.

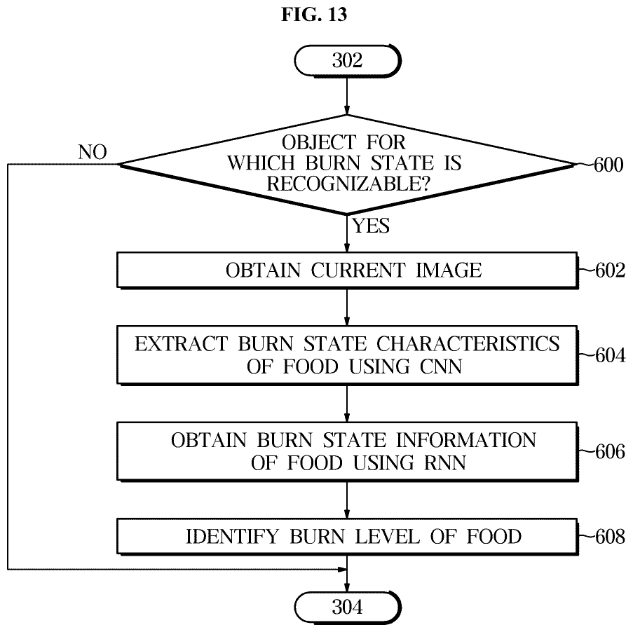

FIG. 13 is a flowchart illustrating operations of estimating a burn state of food using a combination of CNN and RNN in a cooking apparatus according to an embodiment.

Referring to FIG. 13, the controller 200 may determine whether the food is an object for which a burn state is recognizable (600).

In a case where the food is an object for which a burn state is recognizable (Yes in operation 600), the controller 200 may obtain a current image of the inside of the chamber 50 through the camera 60 during heating and cooking (602).

The controller 200 may obtain burn state characteristics of the food by using the image (current image or both current image and initial image) of the inside of the chamber 50 and CNN (604). In this instance, the controller 200 may input the current image of the food or both the initial image and the current image of the food into CNN to obtain the burn state characteristics of the food.

The controller 200 may obtain burn state information of the food by using the burn state characteristics of the food and RNN (606). In this instance, the controller 200 may input the burn state characteristics of the food into RNN to obtain the burn state information of the food. The burn state information of the food may include a burn state of the food, such as an unburned state and a burned state, and a probability value of the corresponding burn state, and time-series burn trend.

The burn state characteristics of the food that may be used as an input value of RNN may be one of the following two values. First, the burn state characteristics may be a flattened value of a result value obtained by applying the convolution and pooling in CNN. Second, instead of flattening the result value obtained by applying the convolution and pooling of CNN and then directly inputting the flattened value as the input value of RNN, the flattened value may be passed through a fully connected layer, converting it into an input value of the same dimension, and then the converted value may be input as the input value of RNN. Through the above, pixel values may be prevented from being input to RNN in different orders during the same phase, enabling more accurate classification.

The controller 200 may identify the burn level of the food based on the burn state information of the food (608).

By using the image of the inside of the chamber 50, CNN, and RNN, the current image of the food captured at the current time and the image of the burned state of the food may be compared to determine the probability of the burned state by a percentage and the time-series burn trend (burn change rate), thereby enabling a more reliable estimation of the burn state.

Meanwhile, the burn state information of the food may include a plurality of burn classes of the food, a probability value of a corresponding burn class, and time-series burn trend.

For example, the plurality of burn classes may include ‘not burn’, which is a state in which the food is not burned, ‘close to burn’, which is a state close to being burned, ‘burn’, which is a state in which the food is burned, and ‘over burn’, which is a state in which the food is excessively burned.

In this case, a result value obtained by converting the combination of CNN and RNN may be one of ‘Chicken, Not Burn, N1%, d(Nn-Nn_1)/dt%’, ‘Chicken, Close to Burn, N2%, d(Nn-Nn_1)/dt%’, ‘Chicken, Burn, N3%, d(Nn-Nn_1)/dt%’, or ‘Chicken, Over Burn, N4%, d(Nn-Nn_1)/dt%’.

Meanwhile, the result value obtained by converting the combination of CNN and RNN may include all of ‘Chicken, Not Burn, N1%, d(Nn-Nn_1)/dt%’, ‘Chicken, Close to Burn, N2%, d(Nn-Nn_1)/dt%’, ‘Chicken, Burn, N3%, d(Nn-Nn_1)/dt%’, and ‘Chicken, Over Burn, N4%, d(Nn-Nn_1)/dt%’. In this case, the four burn classes, probability values, and time-series burn trend may be compared to determine one burn class, probability value, and time-series burn trend at the corresponding point in time among the four. In this instance, the time-series burn trend may include not only a burn trend based on the current and previous probability values, but also a burn trend based on the current and previous burn classes.

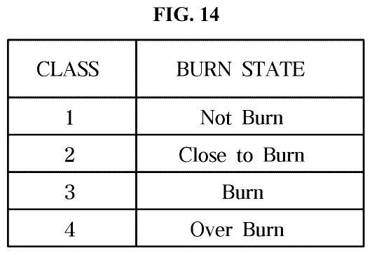

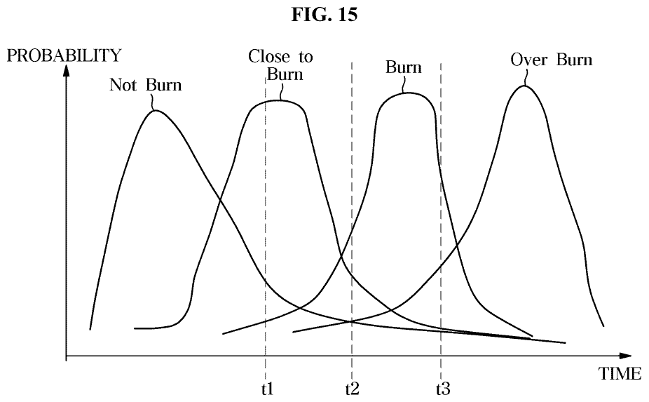

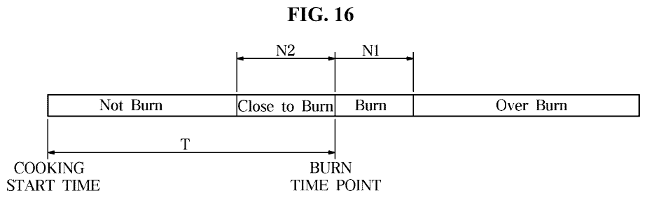

FIG. 14 illustrates burn states of food by class as estimated by a trained model in a cooking apparatus according to an embodiment. FIG. 15 is a graph illustrating burn states of food by class over time in a cooking apparatus according to an embodiment. FIG. 16 illustrates burn state sections of food by class in a cooking apparatus according to an embodiment.

Referring to FIG. 14 to FIG. 16, the trained model may be, for example, a model with four outputs, which indicates that four burn classes exist.

For example, burn classes 1, 2, 3, and 4 may be ‘not burn’, ‘close to burn’, ‘burn’, and ‘over burn’, which are time series of burn states, respectively.

In a case where four outputs, ‘Not Burn, N1 %’, ‘Close to Burn, N2%’, ‘Burn, N3%’, and ‘Over burn, N4%’ outputted from the trained model, are received as time series data and drawn as a graph, the outputs may be represented as shown in the graph of FIG. 15.

A burning notification time may be flexibly adjusted. T1 may be a notification time for a ‘close to burn’. T2 may be a notification time for an intermediate time during transition from ‘close to burn’ to ‘burn’. T3 may be a notification time for a ‘burn’.

A ‘not burn’ section may be set as a section after a preset time has elapsed from a cooking start time.

A ‘close to burn’ section N2 may be a predetermined section shortly before the ‘burn’.

A ‘burn’ section N1 may be a predetermined section immediately after the ‘burn’.

An ‘over burn’ section may be a section following an end of the ‘burn’ section N1.

The ‘close to burn’ section N2 and the ‘burn’ section N1 may have the same time duration.

In a case where a time from the cooking start time to the ‘burn’ is T, the ‘close to burn’ section N2 and the ‘burn’ section N1 may each be 0.2T.

Accordingly, through the user interface 40, the controller 200 may notify a user of the burn level at the corresponding time for each burn level of the food.

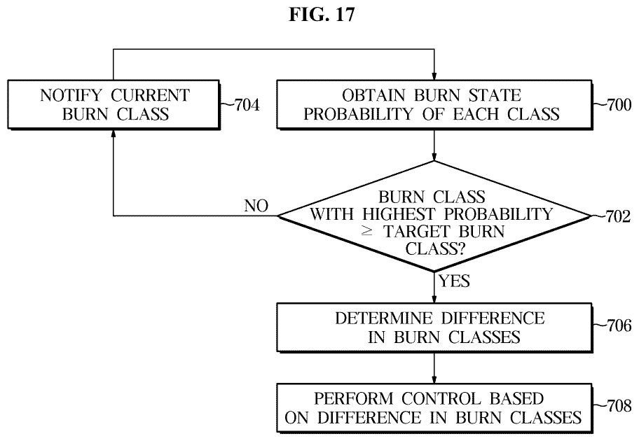

FIG. 17 is a flowchart illustrating control based on a difference between a current burn class and a target burn class.

Referring to FIG. 17, the controller 200 may obtain a burn state probability of each class of the food using the trained model (700).

The controller 200 may compare a burn class with the highest probability among the burn state probabilities of each class of the food with a target burn class to determine whether the burn class with the highest probability (current burn class) is higher than the target burn class (702).

In a case where four burn state probabilities of each class are ‘Not Burn, 30%’, ‘Close to Burn, 40%’, ‘Burn, 60%’, and ‘Over Burn, 30%’, ‘Burn, 60%’ with the highest probability value may be determined as the current burn class.

Meanwhile, in a case where the output of the trained model includes not only the burn class and the probability value but also a time-series burn trend, the burn class with the highest probability value is not determined as the current burn class, i.e., after correcting each burn class using the time-series burn trend, a burn class with the highest probability among the corrected burn state probabilities of each class is determined as the current burn class.

For example, in the case of ‘close to burn’→‘burn’→‘close to burn’, when the burn class contradicts a chronological order, ‘close to burn’ may be estimated as ‘burn’ for a predetermined period of time.

In addition, in a case where the burn class changes directly from ‘close to burn’ to ‘over burn’ and chronologically exceeds the intermediate burn class, ‘over burn’ may be estimated as ‘burn’, which is the intermediate burn class, for a predetermined period of time.

As such, by utilizing the time-series burn trend, a previous burn class and a current burn class may be compared, and in a case where the current burn class contradicts a chronological order or a difference between the previous burn class and the current burn class is greater than a preset difference, the current burn class may be corrected.

In response to the burn class with the highest probability being lower than the target burn class (No in operation 702), the controller 200 may notify the user of the current burn class through the user interface 40 (704).

Meanwhile, in response to the burn class with the highest probability being greater than or equal to the target burn class (Yes in operation 702), the controller 200 may determine a difference in burn classes between the highest probability burn class and the target burn class (706).

The controller 200 may perform control based on the difference in burn classes (708).

Any one of ‘alarm’, ‘pause’, or ‘stop’ may be performed based on the difference between the target burn class and the current burn class. ‘Alarm’ is to notify the user that the food is burned. ‘Pause’ is to notify the user that the food is burned and to maintain a temperature inside the chamber without stopping the heating process. ‘Stop’ is to notify the user that the food is burned and to stop the heating process and lower the temperature inside the chamber.

For example, in a case where the current burn class is 2 levels higher than the target burn class, ‘stop’ may be performed (e.g., current burn class is Over Burn, target burn class is Close to Burn).

In addition, in a case where the current burn class is 1 level higher than the target burn class, ‘pause’ may be performed (e.g., current burn class is Over Burn, target burn class is Burn).

In addition, in a case where the current burn class is the target burn class, ‘alarm’ may be performed (e.g., current burn class is Burn, target burn class is Burn).

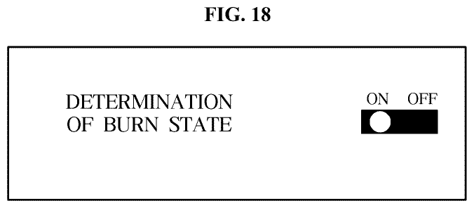

FIG. 18 illustrates a screen for setting a burn state identification function in a cooking apparatus according to an embodiment.

Referring to FIG. 18, a screen for setting a function to identify a burn state of food using a trained model is shown.

A user may activate the burn state identification function by selecting either the ON or OFF button on the function setting screen displayed on the user interface 40.

The burn state identification function may include a burn state identification function using CNN and a burn state identification function using a combination of CNN and RNN. In this case, the user may select a desired function to activate between the two functions.

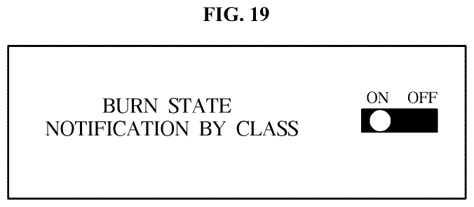

FIG. 19 illustrates a screen for setting a burn state notification function by class in a cooking apparatus according to an embodiment.

Referring to FIG. 19, a screen for setting a burn state notification function for each class is shown.

A user may activate the burn state notification function by class by selecting either the ON or OFF button on the function setting screen displayed on the user interface 40.

For example, when the user activates the burn state notification function by class, the user may be notified each time the burn state of the food is one of the four: ‘not burn’, ‘close to burn’, ‘burn’, and ‘over burn’.

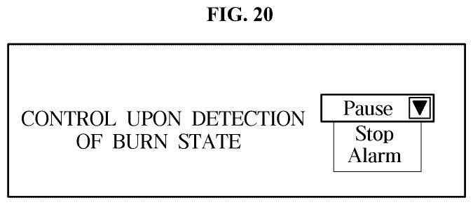

FIG. 20 illustrates a screen for setting a control function upon detection of a burn state in a cooking apparatus according to an embodiment.

Referring to FIG. 20, a screen for setting a control function to be performed when detecting the ‘burn’ state of food is shown.

A user may select one of ‘pause’, ‘stop’, and ‘alarm’ to control the cooking apparatus 1 upon detection of the ‘burn’ state of the food. Accordingly, a customized control for each user may be provided upon detection of the ‘burn’ state of the food.

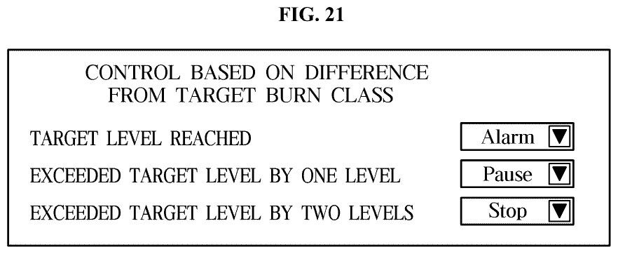

FIG. 21 illustrates a screen for setting a control function based on a difference between a current burn class and a target burn class in a cooking apparatus according to an embodiment.

Referring to FIG. 21, a screen for setting control based on a difference from a target burn class is shown.

A user may set to perform one of the following controls: alarm, pause, and stop based on the difference between the current burn class and the target burn class through the user interface 40.

For example, the user may set to perform ‘alarm’ based on the current burn class reaching a target level.

The user may set to perform ‘pause’ based on the current burn class exceeding the target level by one level.

The user may set to perform ‘stop’ based on the current burn class exceeding the target level by two levels.

Accordingly, various controls of the cooking apparatus 1 may be selected based on the difference between the current burn class and the target burn class. Through the above, controls may be performed differently for each target level and each user, and thus a user-customized control may be performed.

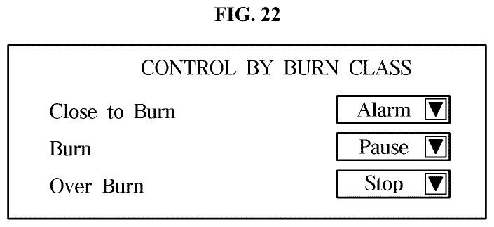

FIG. 22 illustrates a screen for setting a control function by burn class in a cooking apparatus according to an embodiment.

Referring to FIG. 22, a screen for setting control functions by burn class is shown.

A user may select a desired control by burn class of food through the user interface 40.

For example, the user may set to perform ‘alarm’ among the plurality of controls, in a case where a burn state of the food is ‘close to burn’.

The user may set to perform ‘pause’ among the plurality of controls, in a case where a burn state of the food is ‘burn’.

The user may set to perform ‘stop’ among the plurality of controls, in a case where a burn state of the food is ‘over burn’.

Accordingly, a user-customized control may be performed by burn class of the food.

According to an embodiment of the disclosure, a cooking apparatus 1 may include: a chamber 50 configured to accommodate an object to be cooked; a camera 60 configured to obtain an image of an inside of the chamber 50; memory 220 configured to store a model trained for estimating a burn state of the object to be cooked; a user interface 40; and a controller 200 configured to be connected to the camera 60, the memory 220, and the user interface 40. The controller may be configured to estimate the burn state of the object to be cooked obtained by the camera using the trained model, and control the user interface to notify a user of the burn state of the object to be cooked.

The controller may be configured to estimate the burn state of the object to be cooked by inputting a current image of the object to be cooked or by inputting an initial image and the current image of the object to be cooked to the trained model.

The trained model may be a combination of a convolutional neural network (CNN) and a recurrent neural network (RNN).

The controller may be configured to determine whether the object to be cooked is an object for which a burn state is recognizable based on at least one of a color of the object to be cooked before cooking, a change in color of the object to be cooked, or a change in shape of the object to be cooked during cooking, and estimate the burn state of the object to be cooked in response to the object to be cooked being the object for which the burn state is recognizable.

The controller may be configured to obtain burn state information including a plurality of burn classes of the object to be cooked and a probability value of a corresponding burn class using the trained model, and identify a burn level of the object to be cooked based on the burn state information.

The controller may be configured to obtain burn state information including a plurality of burn classes of the object to be cooked, a probability value of a corresponding burn class, and a time-series burn trend using the trained model, and identify a burn level of the object to be cooked based on the burn state information.

The controller may be configured to compare a previous burn level and a current burn level of the object to be cooked, and correct the current burn level in response to the current burn level contradicting a chronological order or in response to a difference between the previous burn level and the current burn level being greater than a preset difference.

The controller may be configured to notify the user of a burn level of the object to be cooked at a corresponding time point for each burn level.

The controller may be configured to set a heating control based on a burn level of the object to be cooked according to a command input by a user via the user interface.

The controller may be configured to perform a heating control based on a burn level of the object to be cooked.

According to an embodiment of the disclosure, a method for controlling a cooking apparatus may include: obtaining an image of an inside of a chamber 50; estimating a burn state of an object to be cooked in the image using a model trained for estimating the burn state of the object to be cooked; and notifying a user of the burn state of the object to be cooked via a user interface 40.

The estimating of the burn state of the object to be cooked may include estimating the burn state of the object to be cooked by inputting a current image of the object to be cooked or by inputting an initial image and the current image of the object to be cooked to the trained model.

The trained model may be a combination of a convolutional neural network (CNN) and a recurrent neural network (RNN).

The estimating of the burn state of the object to be cooked may include determining whether the object to be cooked is an object for which a burn state is recognizable based on at least one of a color of the object to be cooked before cooking, a change in color of the object to be cooked, or a change in shape of the object to be cooked during cooking, and estimating the burn state of the object to be cooked in response to the object to be cooked being the object for which the burn state is recognizable.

The estimating of the burn state of the object to be cooked may include obtaining burn state information including a plurality of burn classes of the object to be cooked and a probability value of a corresponding burn class using the trained model, and identifying a burn level of the object to be cooked based on the burn state information.

The estimating of the burn state of the object to be cooked may include obtaining burn state information including a plurality of burn classes of the object to be cooked, a probability value of a corresponding burn class, and a time-series burn trend using the trained model, and identifying a burn level of the object to be cooked based on the burn state information.

The estimating of the burn state of the object to be cooked may include comparing a previous burn level and a current burn level of the object to be cooked, and correcting the current burn level in response to the current burn level contradicting a chronological order or in response to a difference between the previous burn level and the current burn level being greater than a preset difference.

The notifying of the burn state of the object to be cooked may include notifying the user of a burn level of the object to be cooked at a corresponding time point for each burn level.

The method may further include setting a heating control based on a burn level of the object to be cooked according to a command input by a user via the user interface.

The method may further include performing a heating control based on a burn level of the object to be cooked.

As described above, the cooking apparatus and the method for controlling the same may estimate a burn state of food in a chamber using a trained model, thereby accurately identifying whether the food is burned or not.

In addition, the cooking apparatus and the method for controlling the same may notify a user of a burn state of food, thereby providing accurate cooking information to the user.

One or more embodiments of the disclosure may be implemented in the form of a storage medium for storing instructions to be carried out by a computer. The instructions may be stored in the form of program codes, and when executed by a processor, may generate program modules to perform operation in the embodiments of the disclosure.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the ‘non-transitory storage medium’ may include a buffer that temporarily stores data.

In an embodiment of the disclosure, the aforementioned method according to the one or more embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smart phones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although certain example embodiments of the disclosure have been provided for illustrative purposes, the scope of the disclosure is limited to the embodiments of the disclosure. One or more embodiments that may be modified and altered by those skilled in the art without departing from the principles and spirit of the disclosure, the scope of which is defined in the claims, should be construed as falling within the scope of the disclosure.

What is claimed is:

1. A cooking apparatus comprising:
a chamber configured to accommodate an object to be cooked;
at least one camera configured to obtain one or more images of an inside of the chamber;
memory configured to store an artificial intelligence (AI) model trained for estimating a burn state of the object to be cooked;
a user interface; and
at least one processor operatively connected to the at least one camera, the memory, and the user interface,
wherein the at least one processor, individually or collectively, is configured to:
estimate the burn state of the object to be cooked based on the one or more images obtained by the at least one camera using the AI model, and
control the user interface to provide a notification indicating the burn state of the object to be cooked.

2. The cooking apparatus of claim 1, wherein the at least one processor, individually or collectively, is configured to estimate the burn state of the object to be cooked by one of:
inputting one or more current images of the object to be cooked into the AI model; and
inputting an initial image and the one or more current images of the object to be cooked into the AI model.

3. The cooking apparatus of claim 1, wherein the at least one processor, individually or collectively, is configured to:
determine whether the object to be cooked is an object for which the burn state is recognizable based on at least one of a color of the object to be cooked before cooking, a change in the color of the object to be cooked, or a change in shape of the object to be cooked during cooking, and
based on the object to be cooked being the object for which the burn state is recognizable, estimate the burn state of the object to be cooked.

4. The cooking apparatus of claim 1, wherein the at least one processor, individually or collectively, is configured to:
obtain, using the AI model, burn state information comprising a probability value based on a comparison of the one or more images of the object to be cooked and one or more reference images of the burn state, and
identify a burn level of the object to be cooked based on the burn state information.

5. The cooking apparatus of claim 1, wherein the at least one processor, individually or collectively, is configured to:
obtain, using the AI model, burn state information comprising a probability value based on a comparison of the one or more images of the object to be cooked and one or more reference images of the burn state, and a time-series burn trend, and
identify a burn level of the object to be cooked based on the burn state information.

6. The cooking apparatus of claim 5, wherein to the at least one processor, individually or collectively, is configured to:
compare a previous burn level and a current burn level of the object to be cooked, and
based on the current burn level contradicting a chronological order or based on a difference between the previous burn level and the current burn level being greater than a preset difference, correct the current burn level.

7. The cooking apparatus of claim 1, wherein the at least one processor, individually or collectively, is configured to provide the notification indicating the burn level of the object to be cooked at corresponding time point for each burn level
8. The cooking apparatus of claim 1, wherein the at least one processor, individually or collectively, is configured to set a heating control based on a burn level of the object to be cooked, based on a command input via the user interface.

9. A method for controlling a cooking apparatus, the method comprising:
obtaining one or more images of an inside of a chamber;
estimating a burn state of an object to be cooked based on the one or more images using an artificial intelligence (AI) model trained for estimating the burn state of the object to be cooked; and
providing, via a user interface, a notification indicating the burn state of the object to be cooked.

10. The method of claim 9, wherein the estimating of the burn state of the object to be cooked comprises one of:
estimating the burn state of the object to be cooked by inputting one or more current images of the object to be cooked into the AI model; or
estimating the burn state of the object to be cooked by inputting an initial image and the one or more current images of the object to be cooked to the AI model.

11. The method of claim 9, wherein the estimating of the burn state of the object to be cooked comprises:
determining whether the object to be cooked is an object for which the burn state is recognizable based on at least one of a color of the object to be cooked before cooking, a change in the color of the object to be cooked, or a change in shape of the object to be cooked during cooking, and
based on the object to be cooked being the object for which the burn state is recognizable, estimating the burn state of the object to be cooked.

12. The method of claim 9, wherein the estimating of the burn state of the object to be cooked comprises:
obtaining burn state information comprising a probability value based on a comparison of the one or more images of the object to be cooked and one or more reference images of the burn state, and
identifying a burn level of the object to be cooked based on the burn state information.

13. The method of claim 9, wherein the estimating of the burn state of the object to be cooked comprises:
obtaining burn state information comprising a probability value based on a comparison of the one or more images of the object to be cooked and one or more reference images of the burn state, and a time-series burn trend using the AI model, and
identifying a burn level of the object to be cooked based on the burn state information.

14. The method of claim 13, wherein the estimating of the burn state of the object to be cooked comprises:
comparing a previous burn level and a current burn level of the object to be cooked, and
based on the current burn level contradicting a chronological order or based on a difference between the previous burn level and the current burn level being greater than a preset difference, correcting the current burn level.

15. The method of claim 9, wherein the providing the notification indicating the burn state of the object to be cooked comprises providing the notification indicating the burn level of the object to be cooked at corresponding time point for each burn level.

16. A non-transitory computer-readable medium storing one or more instructions that are executable by at least one processor, individually or collectively, cause the at least one processor to:
obtain one or more images of an inside of a chamber;
estimate a burn state of an object to be cooked based on the one or more images using an artificial intelligence (AI) model, the AI model being trained for estimating the burn state of the object to be cooked; and
provide, via a user interface, a notification indicating the burn state of the object to be cooked.
